(19) United States
(12) Patent Application Publication
(10) Pub. No.: US 2015/0292669 A1
(43) Pub. Date: Oct. 15, 2015

(54) Lockable Tablet Stand

(71) Applicant: Engineered Network Systems, Burnsville, MN (US)

(72) Inventors: Peter J. Floersch, Lakeville, MN (US); Steven Nistler, Rosemount, MN (US); Jon Christopherson, Burnsville, MN (US); Cory Benson, Savage, MN (US)

(73) Assignee: Engineered Network Systems, Burnsville, MN (US)

(21) Appl. No.: 14/251,742

(22) Filed: Apr. 14, 2014

(51) Int. Cl. F16M 11/04; G06F 1/16

(52) U.S. Cl. CPC F16M 11/04; G06F 1/1626

(57) ABSTRACT

A lockable electronic tablet stand is described that fixes the tablet in a locked relation to the stand. The stand actuates between a locked and unlocked position and provides an intuitive locking system. Use of a key is required for removal of the tablet from the stand.

### CROSS-REFERENCE TO RELATED APPLICATIONS

Not Applicable

### FEDERAL SPONSORSHIP

Not Applicable

### JOINT RESEARCH AGREEMENT

Not Applicable

### TECHNICAL FIELD

This invention pertains generally to a lockable display or monitor support systems for electronic tablets. More particularly, the invention pertains to a tablet support system that automatically actuates open when unlocked, while providing a support system that also allows the user to decisively position the display at multiple fixed angles and orientations.

### BACKGROUND

Recently, electronic tablets have provided added mobility in contrast to desktop style microprocessor computers. For a variety of reasons many users desire mobility yet also want to be able to use the same device in a conventional way similar to a desktop personal computer. For example, in a retail market it has become popular for sales associates to carry light weight mobile devices or tablets that are wirelessly linked to a network. The tablets may be utilized as a marketing tool and provide additional information for the customer. At the same time, it may be desirable for the sales associate to use the tablet as a stationery computer with a wired connection to a secure network. When using the tablet as a stationery device the user may desire a stand that allows the user to adjust the vertical position, horizontal position, rotational orientation or a combination of these.

Further, the user may desire a stand that partially encloses and locks the tablet within the stand to reduce a potential for removal of the tablet from the stand without authorization. The user may also desire a stand that includes a lock mechanism that autonomously actuates open when unlocked, simplifying removal of the tablet from an unlocked stand.

### SUMMARY

Embodiments according to aspects of the invention provide a tablet support stand that includes locking retention members that engage side portions of the tablet without interfering with the viewable screen portion of the tablet. The support stand also includes a lock and key mechanism interconnected with the retention members. Those skilled in the art will appreciate that several different types of locking mechanisms may be incorporated into the tablet support stand to lock the retention member in a fixed position relative to the frame. For example, the lock mechanism may be a plunger, cam or tubular push lock. In an embodiment of the invention, one or more retention members actuate to an open position automatically when the lock mechanism is turned or otherwise oriented to an unlocked position. Further, when the retention members are slid or otherwise oriented in the closed position a lock mechanism may, for example without limitation intended, actuate manually to a locked position, thereby engaging and securing the retention members.

In accordance with aspects of the invention, an embodiment of the invention includes a support stand having a frame, retention members, slide plate, lock mechanism and actuating members. The slide plate includes at least one retention member that is attached in a sliding relation to the frame. The slide is further aligned coaxially to a longitudinal axis of the frame and cooperates with a second retention member to retain a tablet securely between the retention members. The actuating member actuates the slide between an open and a closed position. The lock mechanism is preferably activated with a key and is coupled between the frame and the slide plate. In this manner, the lock mechanism engages the frame and slide plate when in the locked position and disengages from at least one of the slide plate and the frame when unlocked. The stand further includes a rotational and pivotal hinge mount coupled to the frame to allow the user to decisively position the display at multiple angles and orientations.

In accordance with an embodiment of the invention the apparatus securely supports an electronic tablet and includes a base, a support column, a frame, and a keyed locking mechanism. The support column has a first end portion coupled to the base and a second end portion coupled to the frame. The support further includes a multidirectional joint that allows the user to decisively position the display at multiple angles and orientations. The frame has retention members to securely couple the electronic tablet to the frame. The lock mechanism is coupled to the frame in a manner so that the lock mechanism retains at least one retention member in a fixed position when the lock mechanism is oriented in a locked position and releases the retention member when the lock mechanism is oriented in an unlocked position. The frame may further include a slide having a retention member, wherein an actuation member actuates the slide relative to the frame between an open and closed position.

In use, when the lock mechanism is oriented in the unlocked position an actuating member or spring forces the slide and first retention member into an open position. The open position allows the user to position one end of a tablet under an opposing second retention member while aligning the tablet with the slide and first retention member. Once the tablet is positioned under the retention member, the slide may be slid towards the tablet until the corresponding first retention member aligns over an edge of the tablet. A lock may be utilized to fix the slide in a locked position relative to the frame once the first retaining member is positioned over the edge of the tablet. The lock incorporated into the stand may be a latch bolt, plunger, cam, tubular push, or other suitable lock type and may require a corresponding key to disengage the lock mechanism. In this manner the user may securely engage the tablet within the stand.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components.

FIG. 1 is a front left perspective view of an electronic tablet stand in accordance with an embodiment of the invention, illustrating an electronic tablet retained in the stand;

FIG. 2 is a back right perspective view of an electronic tablet stand of the type shown in FIG. 1;

FIG. 3 is a front right perspective view of an electronic tablet support stand in accordance with an embodiment of the invention, illustrating a retention member in an open position to allow removal of the tablet from the stand;

FIG. 4 is a back right perspective view of an electronic tablet stand of the type shown in FIG. 3 further illustrating the lock mechanism in an unlocked position;

FIG. 5 is a left perspective view of an electronic tablet stand in accordance with an embodiment of the invention, illustrating an electronic tablet retained in the stand;

FIG. 6 is a back left perspective view of an electronic tablet stand of the type shown in FIG. 5;

FIG. 7 is a front right perspective view of an electronic tablet support stand in accordance with an embodiment of the invention, illustrating a retention member in an open position to allow removal of the tablet from the stand;

FIG. 8 is a back left perspective view of an electronic tablet stand of the type shown in FIG. 7 further illustrating the lock mechanism in an unlocked position;

FIG. 9 is a front left perspective view of an electronic tablet stand in accordance with an embodiment of the invention, illustrating an electronic tablet absent from the stand and the retention member in a closed position;

FIG. 10 is a front right perspective view of an electronic tablet stand of the type shown in FIG. 9, illustrating the retention member in an open position;

FIG. 11 is a front left perspective view of an electronic tablet stand in accordance with an embodiment of the invention, illustrating an electronic tablet absent from the stand and the retention member in a closed position;

FIG. 12 is a back left perspective view of an electronic tablet stand of the type shown in FIG. 11.

FIG. 13 is a front right perspective view of an electronic tablet stand of the type shown in FIG. 11, illustrating the retention member in an open position;

FIG. 14 is a partial exploded and elevated front perspective view of an electronic tablet stand in accordance with an embodiment of the invention, illustrating an actuating s-spring in a compressed state and with components hidden to reveal the s-spring;

FIG. 15 is a partial exploded and elevated front perspective view of the stand of the type shown in FIG. 14 with the s-spring in a relaxing position;

FIG. 16 is a partial exploded and elevated back perspective view of an electronic tablet stand in accordance with an embodiment of the invention, illustrating an actuating s-spring in a compressed state and with components hidden to reveal the s-spring;

FIG. 17 is a partial exploded and elevated back perspective view of the stand of the type shown in FIG. 16 with the s-spring in a relaxing position;

FIG. 18 is a partial exploded and elevated front perspective view of an electronic tablet stand in accordance with an embodiment of the invention, illustrating a slide in a closed position and a torsion spring in a compressed state and with components hidden to reveal the torsion spring;

FIG. 19 is a partial exploded and elevated back perspective view of an electronic tablet stand in accordance with an embodiment of the invention, illustrating a slide in a closed position and a torsion spring in a compressed state and with components hidden to reveal the torsion spring;

FIG. 20 is a partial exploded and elevated front perspective view of an electronic tablet stand in accordance with an embodiment of the invention, illustrating a slide actuated to an open position and a torsion spring in a relaxing position and with components hidden to reveal the torsion spring; and

FIG. 21 is a partial exploded and elevated back perspective view of an electronic tablet stand in accordance with an embodiment of the invention, illustrating a slide actuated to an open position and a torsion spring in a relaxing position and with components hidden to reveal the torsion spring.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

The support system of the present invention is particularly well suited as a lockable and adjustable tablet support system. The support system may include a base, frame, slides, locking mechanism, and display support bracket. In accordance with the present invention a user positions the tablet between retention members and then locks the tablet to the stand by sliding at least one of the retention members to a closed position. Once in a closed position, the lock retains the retention member in a closed and locked position. An embodiment of the invention requires a corresponding key to unlock the lock so that the tablet may be removed from the stand. A tubular push lock may be utilized so that the lock pin engages the slide and frame when in the locked position and the push button of the lock may actuate outward when in the unlocked position.

Those skilled in the art will appreciate that the various components of the invention may be constructed from suitable known processes, including for example without limitation, die stamping sheet metal or alternatively plastic injection molding components. Further, in a preferred embodiment, the metal components may be fabricated from relatively strong and durable materials, such as nickel steel, carbon steel, galvanized steel, high grade aluminum, and the like. Portions of metal components that contact other moving components may preferably include pads, insets, bushings, spacers, inserts, or other resistance reducing members fabricated from a relatively low coefficient of friction material in order to allow movement of the components parts with little frictional resistance. A particularly preferred material for these resistance reducing members is ultra-high molecular weight polyethylene (UHMWPE), though other polymeric materials may be used in place of UHMWPE.

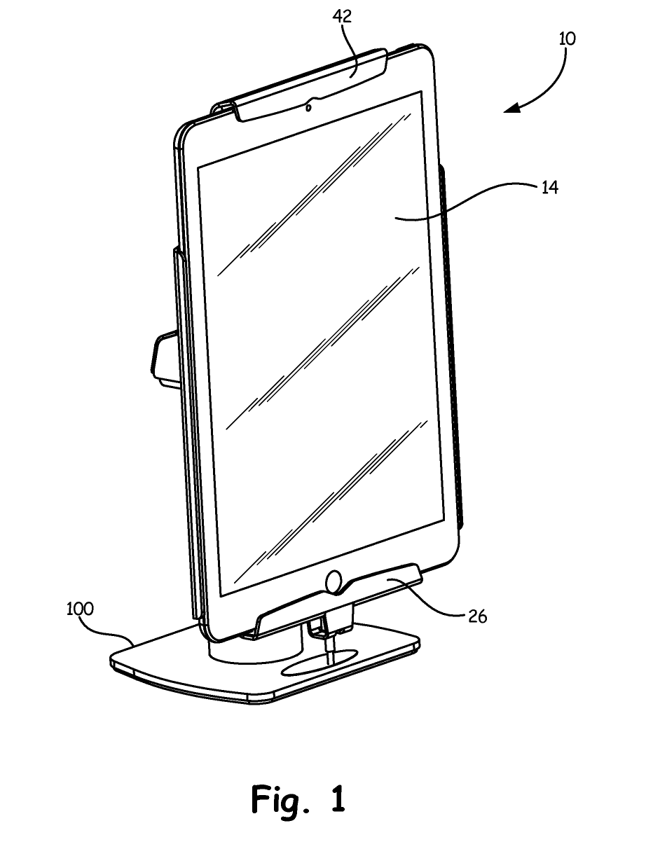

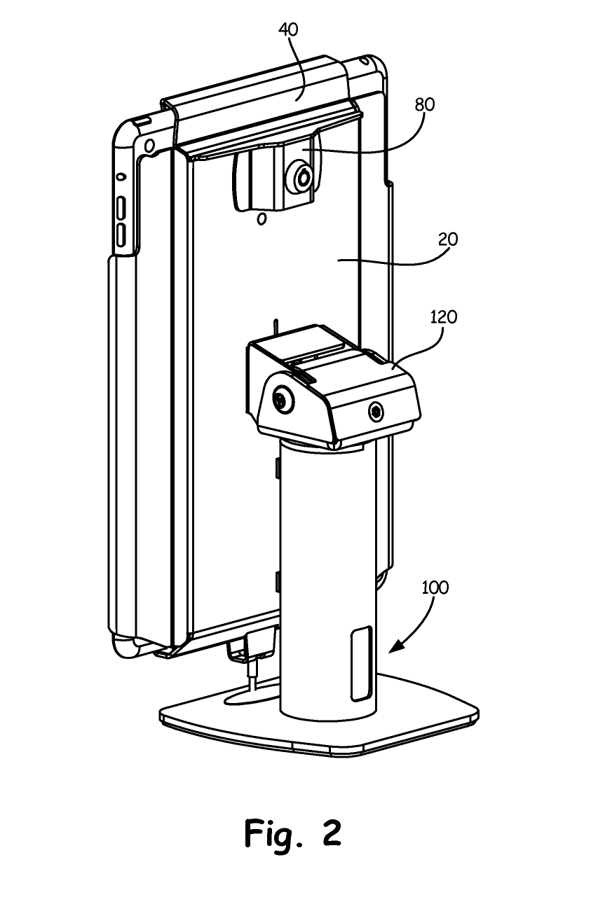

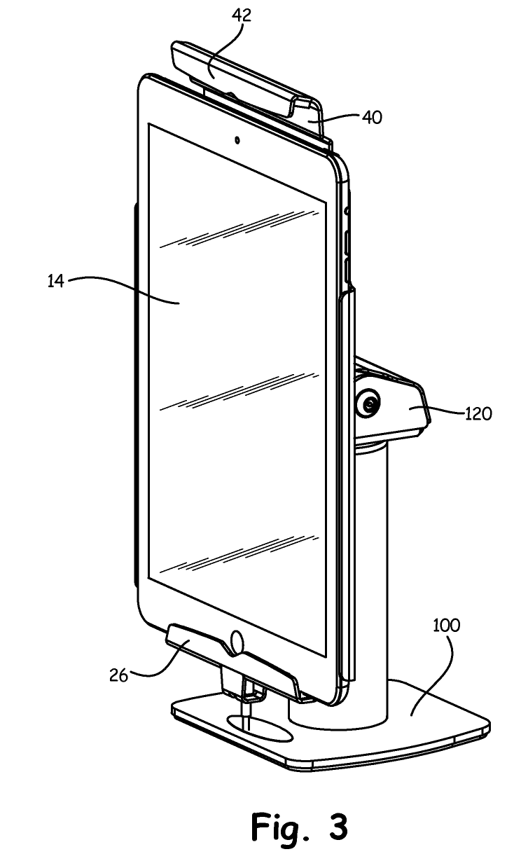

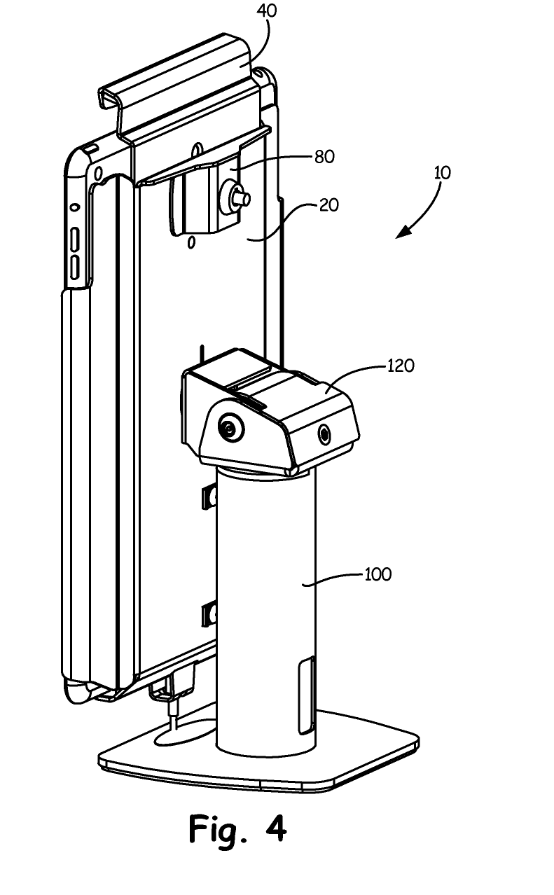

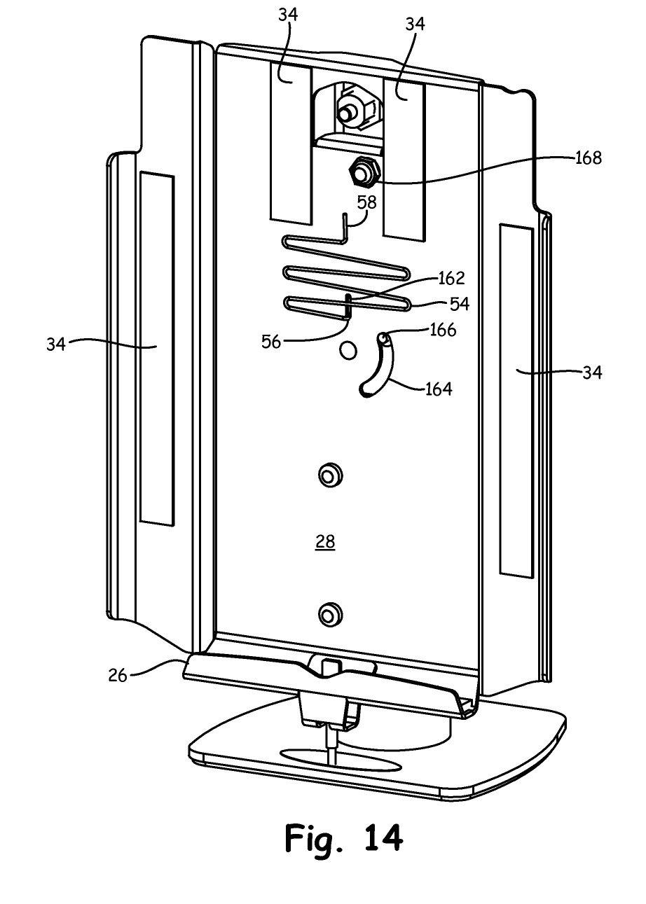

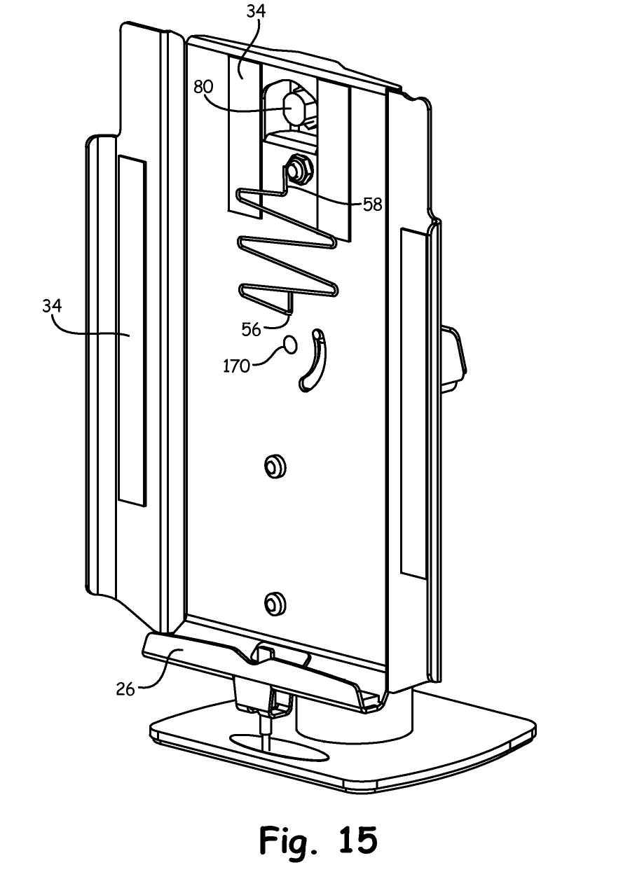

Turning attention now to FIGS. 1-4, a tablet support stand 10 is shown generally including a frame 20, slide plate 40, lock 80, base 100 and hinge pivot 120. The frame may include multiple components including a backing plate or may be a unitary construction. The hinge pivot 120 is constructed in a known suitable fashion to allow horizontal rotation and vertical rotation. The hinge pivot 120 may be attached to the frame 20 in a manner that allows the frame to rotate so that the tablet 14 may be oriented or displayed in a landscape or portrait mode or orientation. An actuating mechanism 50 (see, for example FIGS. 14 and 15) actuates slide plate 40 from a closed position shown in FIGS. 1-2 to an open position illustrated in FIGS. 3-4. When in the open position the tablet 14 may be slid so that the edge of the tablet is no longer in contact with the frame retention member 26. Once the tablet is slid out of contact with the retention member 26, the tablet may be pulled away and out of contact with the stand.

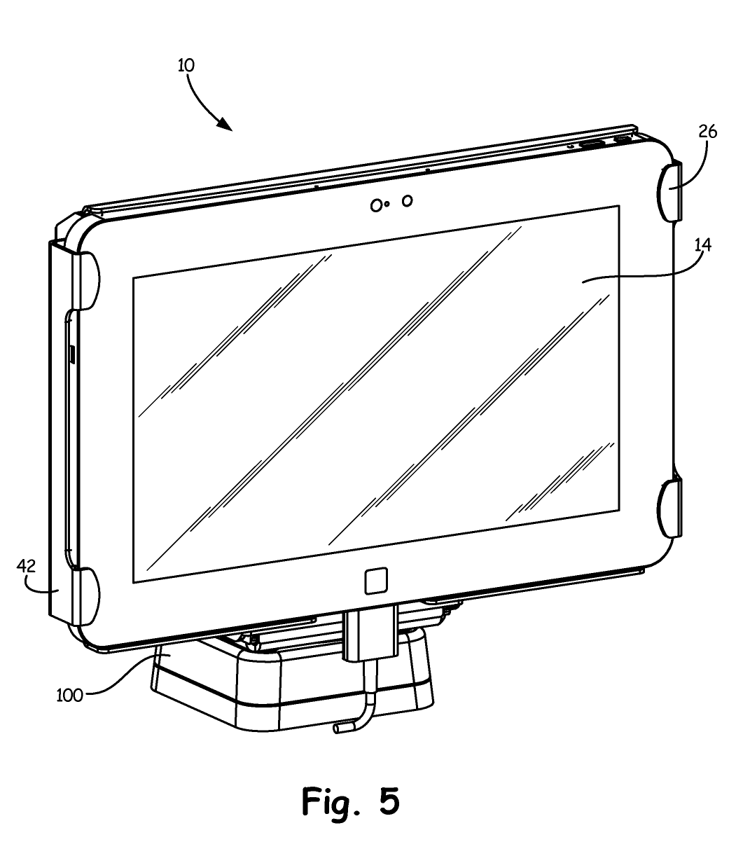

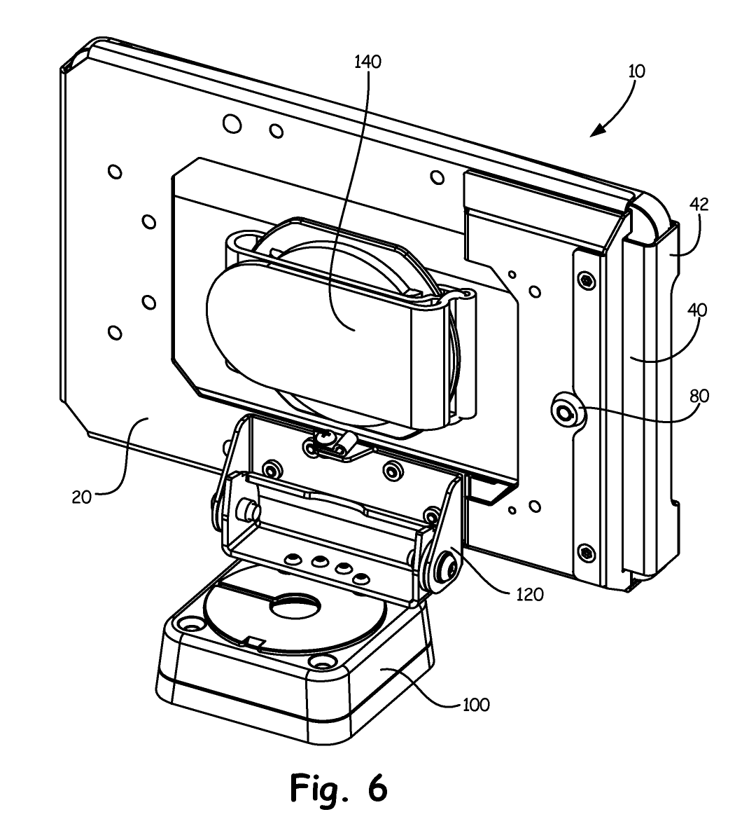

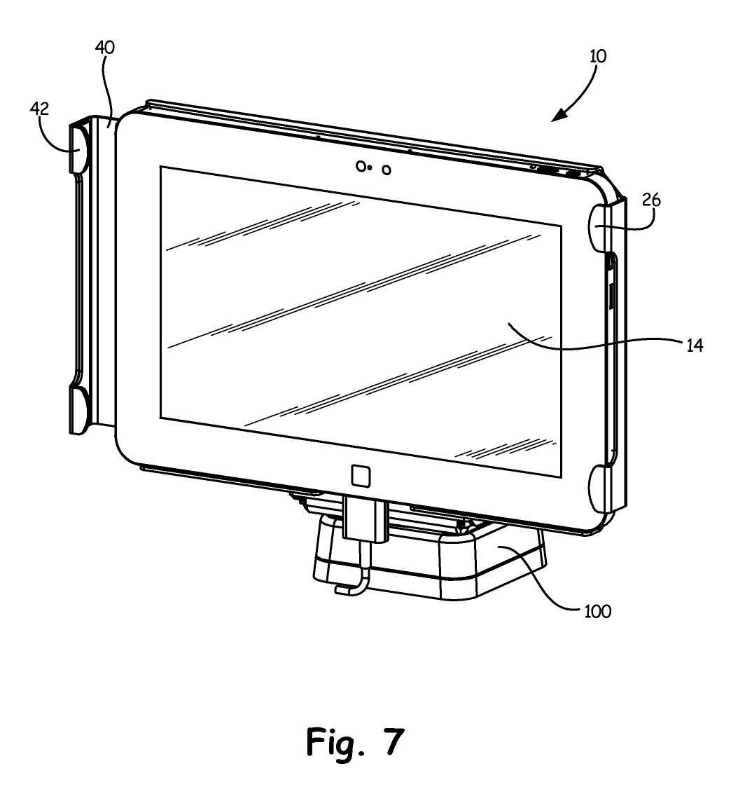

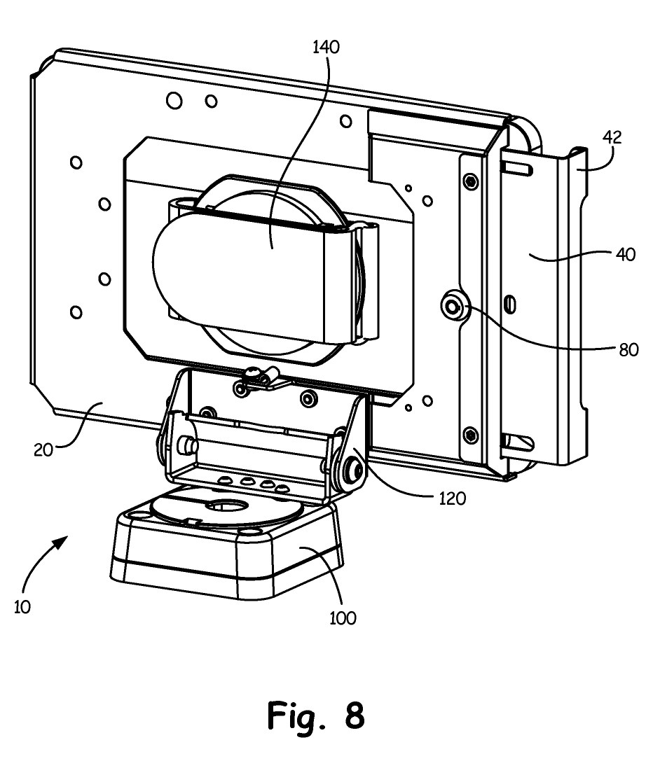

Similarly, FIGS. 5-8 further illustrates an alternate tablet support stand 10. The tablet stand is shown generally including a frame 20, slide plate 40, lock 80, base 100 and hinge pivot 120. The slide plate 40 actuates from a closed position shown in FIGS. 5-6 to an open position illustrated in FIGS. 7-8. The frame 20 is shown rotated so that the tablet is positioned in a landscape orientation. When in the open position the tablet 14 may be slid laterally so that the edge of the tablet is no longer in contact with the frame retention member 26. Once the tablet is slid out of contact with the retention member 26, the tablet may be pulled away and out of contact with the stand.

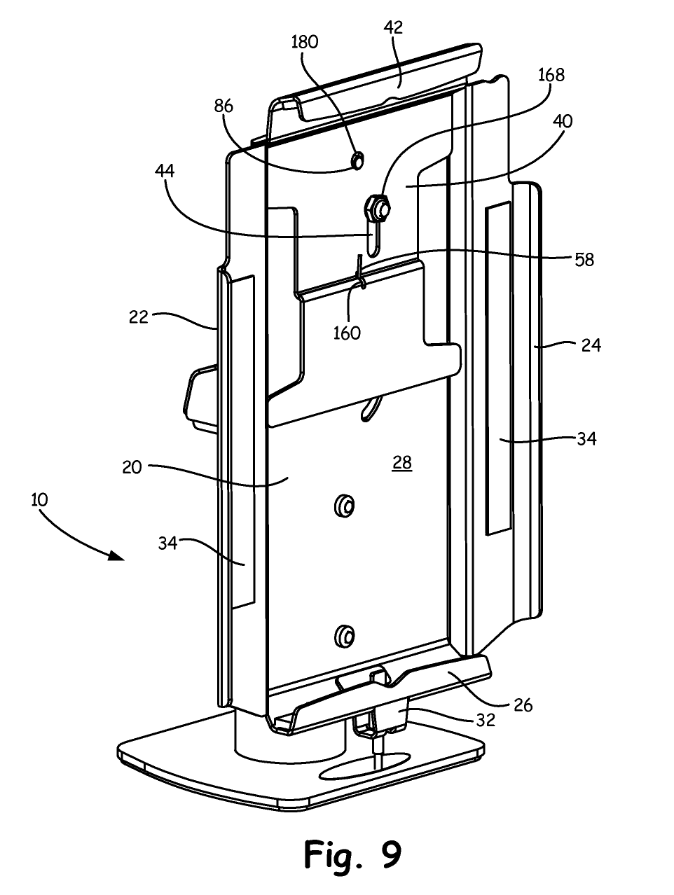

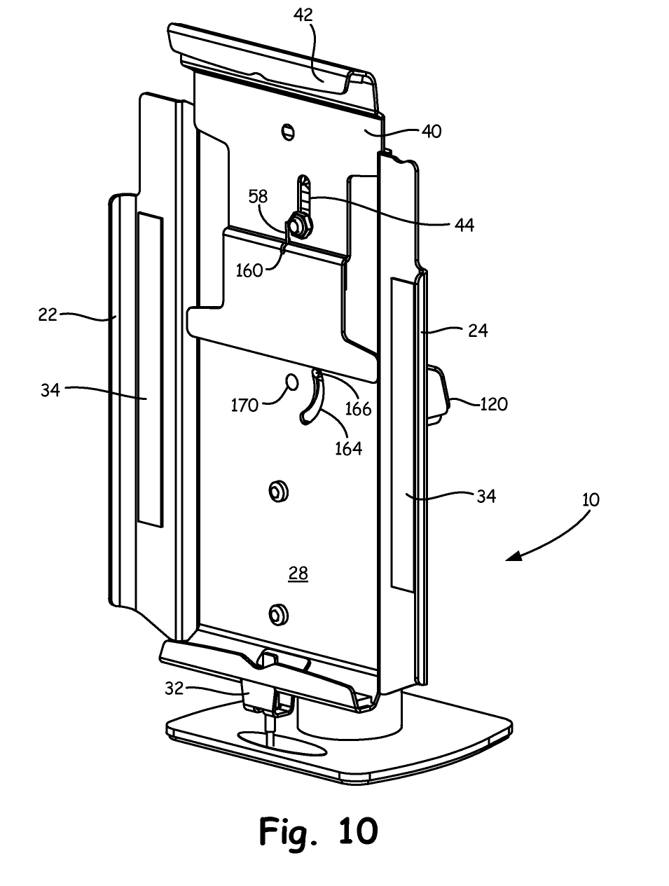

FIGS. 9-10 illustrates the tablet support stand 10 in a portrait orientation with the tablet removed. The slide plate 40 includes a slide guide 44 formed in the plate that receives retention member 168 in a coupling and guiding relation. The retention member 168 extends from the backing plate and couples the slide plate to the frame in a sliding relation. In this manner the slide plate 40 slides or actuates between an open and closed position relative to the frame 20. The actuating member that actuates the slide plate 40 to the open position is shown in FIGS. 14-17 comprising an s-spring 54. A first end 56 of the s-spring couples to the back plate 28 (see FIGS. 14 and 15) and a second end 58 of the s-spring couples to slide plate 40. The second end 58 inserts and is held in place in a slot 160 formed in the slide plate 40. Similarly, the first end 56 inserts and is held in place in a slot 162 formed in the backing plate 28 (see FIG. 14).

Frame 20 includes side flanges 22 and 24 sized to accept the width dimension of the tablet. Friction pads 34 are applied to the frame 20 and have a reduced coefficient of friction to minimize effects of contact between the frame and tablet and between the slide plate and the frame. The frame 20 further includes a cabling conduit 32 that aligns with, for example, a usb port of the tablet to facilitate wired connection between the tablet and a network. The orientation of the frame 20 may be rotated from portrait to landscape by turning the frame about hinge fastener 170 until retention member or stop 166 reaches an end in the arcing slot 164. A resistance reducing washer (not shown) may be aligned with the hinge fastener 170 and positioned between the back plate 28 and hinge pivot 120 to reduce effects of friction when the frame is rotated. Alternatively, the retention member may be sized and shaped from a suitable material to retain the frame 20 in a fixed position.

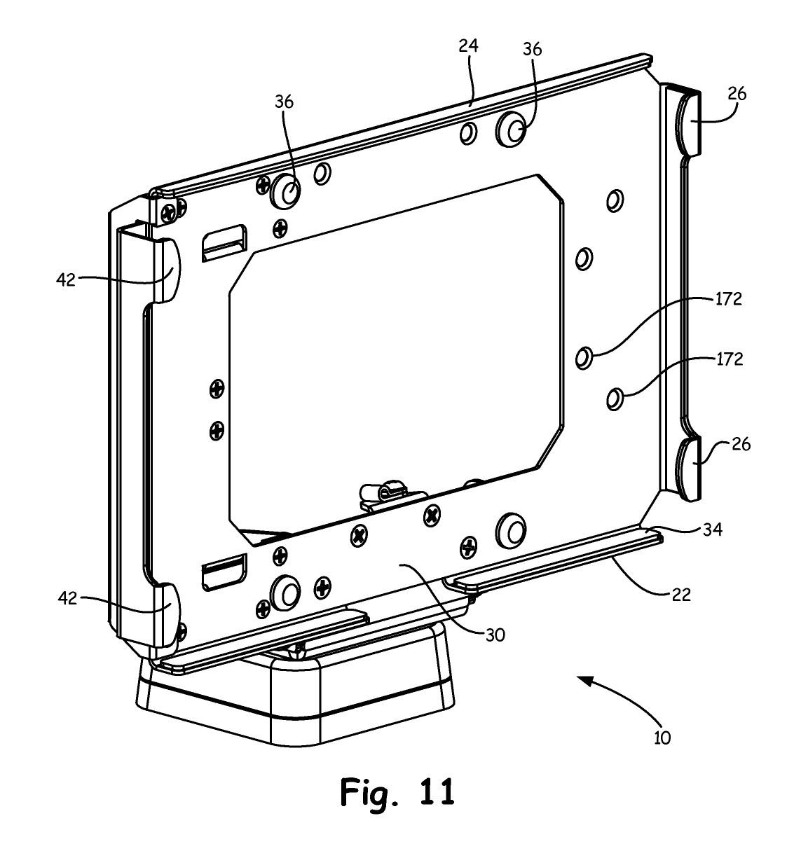

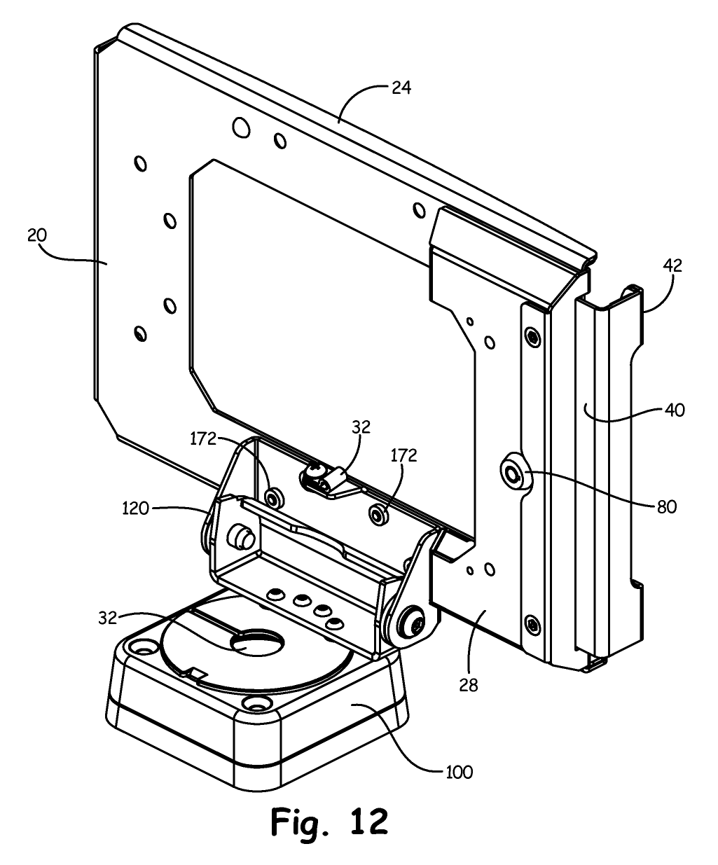

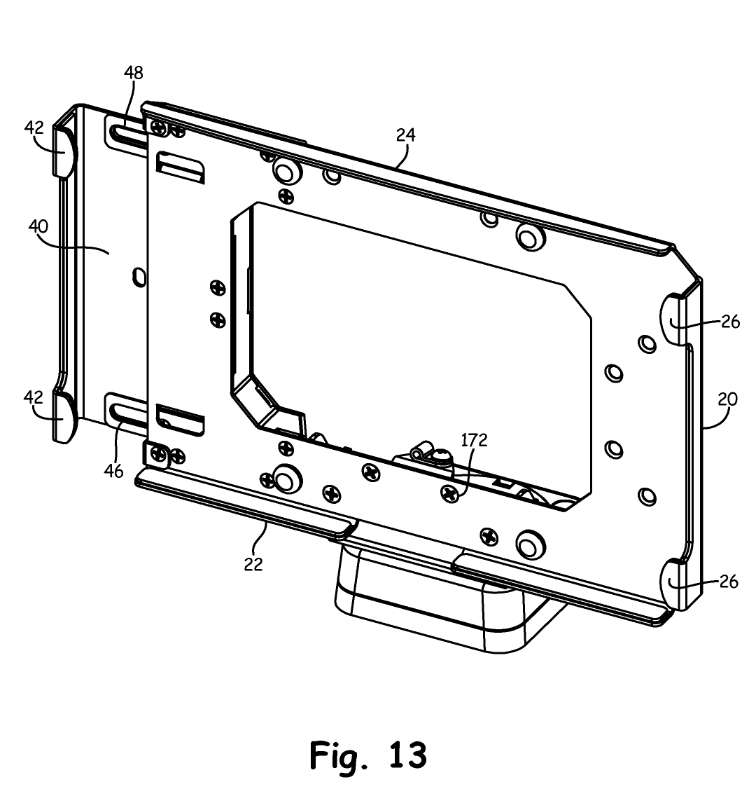

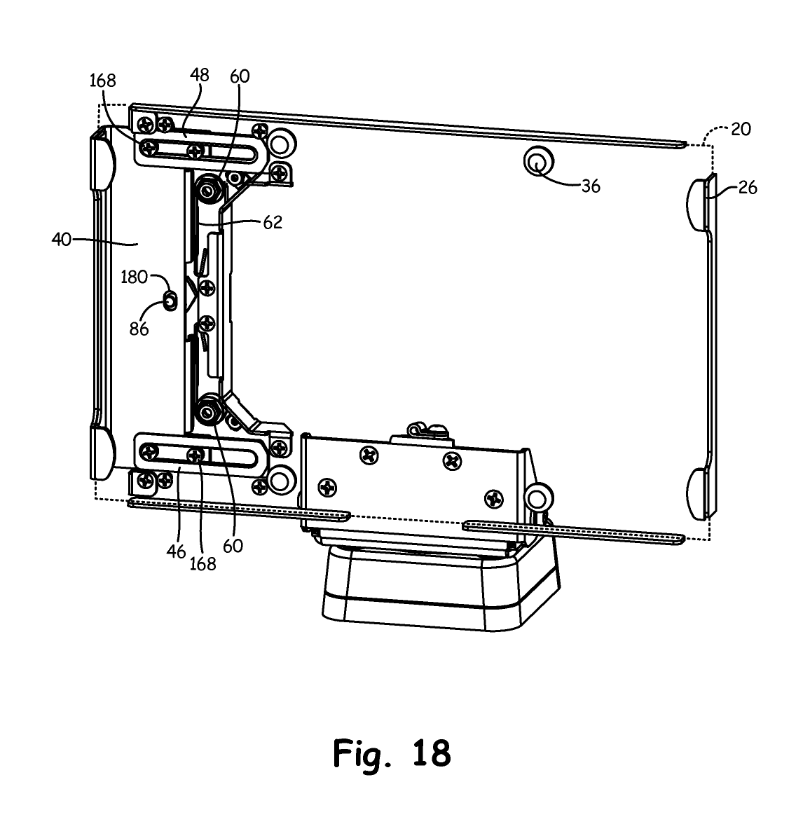

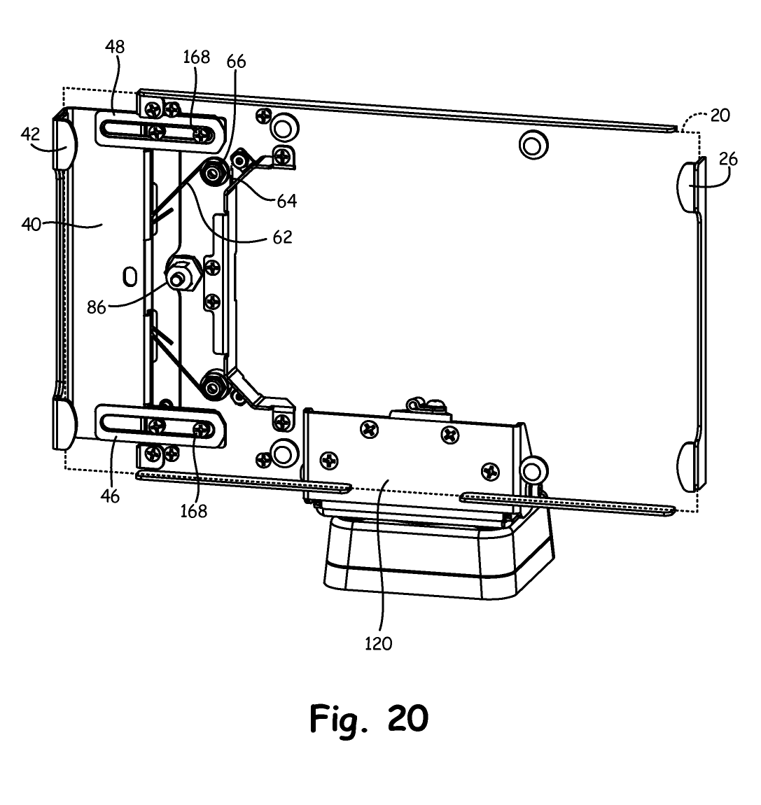

FIGS. 11-13 illustrates the tablet support stand 10 in a landscape orientation with the tablet removed. The backing plate 28 includes slide guides 46 and 48 formed or attached to the backing plate 28. The guides 46 and 48 receive retention members 168 in a coupling and guiding relation (see FIGS. 18 and 20). The retention member 168 extends from the backing plate and couples the slide plate 40 to the frame 20 in a sliding relation. In this manner the slide plate 40 slides or actuates between an open and closed position relative to the frame 20. The actuating member that actuates the slide plate 40 to the open position is shown comprising a torsion spring 60. A first end or arm of the spring presses against a first ledge of the back plate 28 and a leg of the spring presses against a second ledge of the back plate. The main body 66 of the torsion spring is coiled and provides tension that tends to actuate the slide plate to the open position. Front plate 30 attaches to back plate 28 and encloses spring 60 between the front plate and the back plate 28. Frame 20 includes side flanges 22 and 24 sized to accept the width dimension of the tablet. Friction buttons 36 and pads 34 are applied to the frame 20 and have a reduced coefficient of friction to minimize effects of contact between the frame and tablet and between the slide plate and the frame. The frame 20 further includes a cabling conduit 32 that aligns with, for example, a usb port of the tablet to facilitate wired connection between the tablet and a network. The orientation of the frame 20 may be rotated from portrait to landscape by removing fasteners 172 from mount holes, aligning the hinge pivot 120 with alternate mount holes 174 and engaging the hinge pivot with the front plate with fasteners 172.

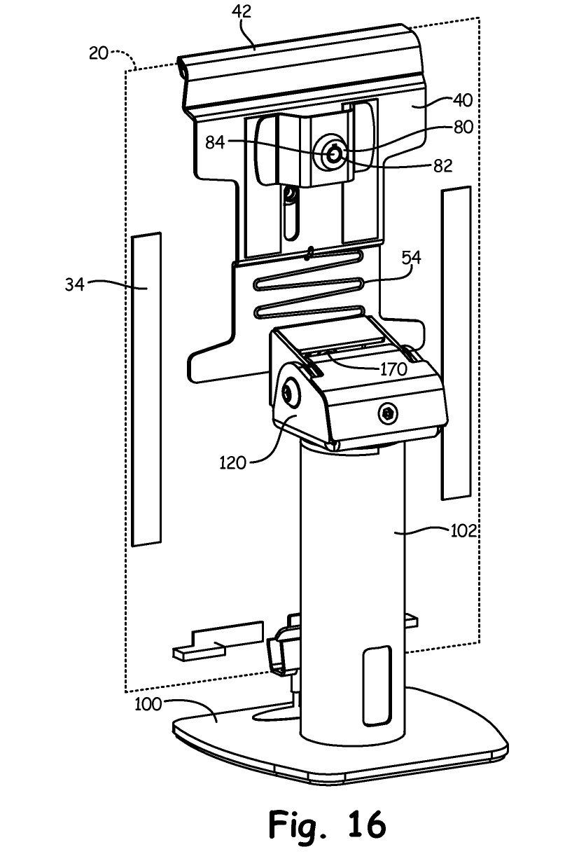

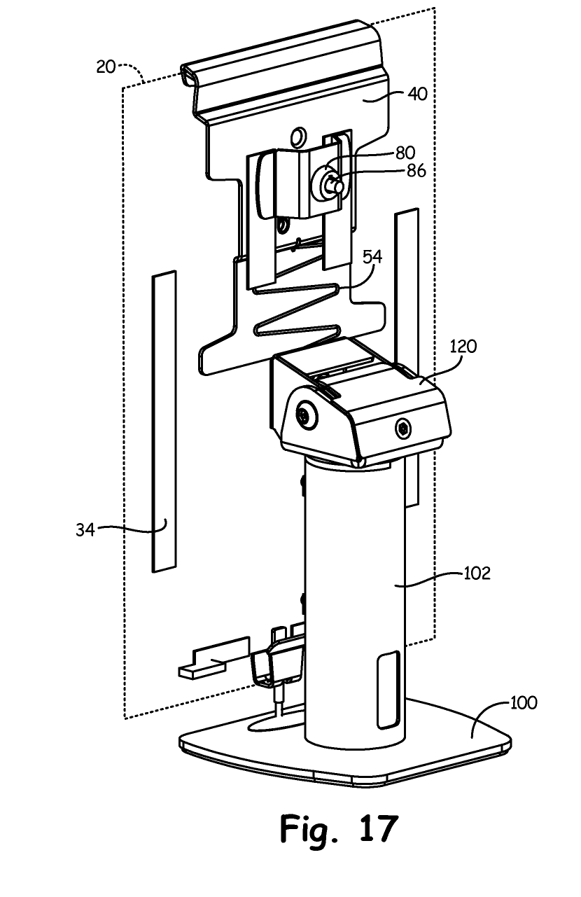

With reference to FIGS. 14-17 the compression and relaxing of s-spring 54 is further illustrated. Specifically, FIGS. 14 and 16 show the s-spring in a compressed state when the slide plate 40 and retention member 42 are in the closed position. When in the compressed state, spring 54 applies a force against slide plate 40 which may actuate the slide plate 40 to the open position if the lock mechanism 80 is unlocked. Similarly, FIGS. 15 and 17 show the s-spring in a relaxed state when the slide plate 40 is in the open position. Pin 86 of lock mechanism actuates between a locked and unlocked position. When in the locked position, pin 86 engages in an aperture 180 of the slide plate 40 (see, for example, FIG. 9).

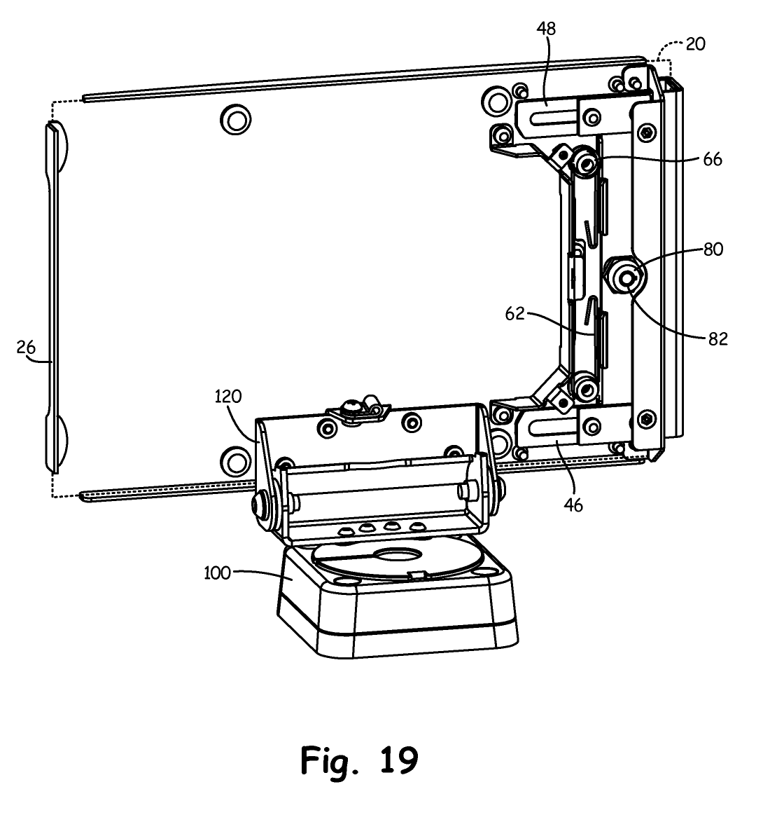

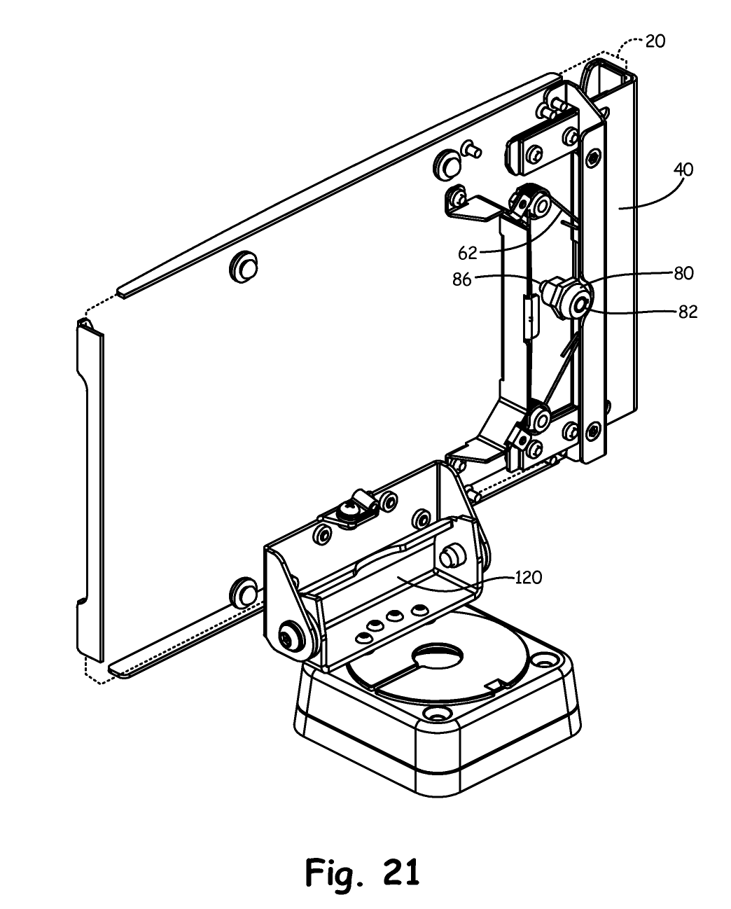

With reference to FIGS. 18-21 the compression and relaxing of torsion spring 60 is further illustrated. Specifically, FIGS. 18 and 19 show the torsion spring in a compressed state when the slide plate 40 and retention member 42 are in the closed position. When in the compressed state, the arms 62 and legs 64 of spring 60 applies a force against slide plate 40 which may actuate the slide plate 40 to the open position if the lock mechanism 80 is unlocked. Similarly, FIGS. 20 and 21 show the torsion spring in a more relaxed state when the slide plate 40 is in the open position. Pin 86 of lock mechanism actuates between a locked and unlocked position. When in the locked position, pin 86 engages in an aperture 180 of the slide plate 40 (see, for example, FIG. 18).

Lock mechanism 80 is of suitable known tubular push lock construction and generally comprises a key hole 82 having a uniquely shaped receptacle sized to receive a corresponding key (not shown). When the key is inserted into the key hole 82 and turned, the pin 86 is released and is actuated outward from the key hole. When the pin 86 is pressed into the key hole an internal mechanism engages the pin and locks the pin in place until the key is turned to release the pin. Those skilled in the art will appreciate that other known lock mechanisms, including without limitation a cam lock or bolt lock, may be incorporated into the slide and frame to lock the slide in a closed position relative to the frame.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. An apparatus to support an electronic tablet, said apparatus comprising:
a backing plate;
a first retention member extending from said backing plate;
a slide coupled to said backing plate, said slide having a second retention member extending from said slide;
an actuating member engaged to said slide to actuate said slide between an open and closed position; and
a lock engaged to said back plate and coupled with said slide, said lock locking said slide in relation to said back plate.

2. The apparatus as recited in claim 1, wherein said lock mechanism further includes a key receiving receptacle, wherein a key may activate said lock mechanism between a locked and unlocked position.

3. The apparatus as recited in claim 1, wherein said actuating member includes an s-spring.

4. The apparatus as recited in claim 1, wherein said actuating member includes a torsion spring.

5. The apparatus as recited in claim 4, wherein said torsion spring includes an arm portion and leg portion, wherein said arm portion is adjacent said slide and said leg portion is adjacent said backing plate.

6. The apparatus as recited in claim 1, wherein said actuating member is aligned between said slide and said backing plate.

7. The apparatus as recited in claim 3, wherein an end of said spring includes a hook to engage a slot formed in said backing plate.

8. The apparatus as recited in claim 1, wherein said backing plate includes slide guides restricting the slide between the open and closed position.

9. The apparatus as recited in claim 1, further including a base having a rotational and pivotal hinge mount coupled to said backing plate.

10. The apparatus as recited in claim 1, further including a wrist strap receiving cavity formed in said backing plate.

11. An apparatus to support an electronic tablet, said apparatus comprising:
a frame having a first retention member;
a slide plate engaged in sliding relation to said frame and engaged coaxial to a longitudinal axis of said frame, said slide plate including a second retention member;
an actuating member to actuate said slide between an open and a closed position;
a keyed lock coupled between said frame and said slide plate that engages the frame and slide plate when in the locked position and disengages from at least one of said slide plate and said frame when unlocked.

12. The apparatus as recited in claim 11, wherein said actuating member includes an s-spring.

13. The apparatus as recited in claim 11, wherein said actuating member includes a torsion spring having an arm portion and leg portion, wherein said arm portion is positioned adjacent said frame.

14. The apparatus as recited in claim 12, wherein an end of said spring includes a hook to engage a slot formed in said frame.

15. The apparatus as recited in claim 11, wherein at least one of said frame and said slide plate includes slide guides restraining the slide between the open and closed position.

16. The apparatus as recited in claim 11, further including a rotational and pivotal hinge mount coupled to said frame.

17. The apparatus as recited in claim 11, further including friction reducing pads positioned between said frame and said slide plate.

18. An apparatus to securely support an electronic tablet, said apparatus comprising:
a base;
a support having a first portion coupled to said base, said support having a multidirectional joint;
a frame having retention members to securely couple an electronic tablet with said frame, wherein said frame is coupled to said support with said multidirectional joint;
a keyed lock coupled to said frame, wherein said lock retains at least one retention member in a fixed position when said lock is in a locked position and releases the at least one retention member when said lock is in an unlocked position.

19. The apparatus as recited in claim 18, wherein said frame includes a slide having at least one retention member, and said slide and frame further includes an actuation member to actuate said slide between an open and closed position.

20. The apparatus as recited in claim 19, wherein said lock engages with said frame and said slide.
